(19) United States
(12) Patent Application Publication
(10) Pub. No.: US 2010/0003407 A1
(43) Pub. Date: Jan. 7, 2010

(54) AQUEOUS INK FOR INKJET RECORDING

(76) Inventor: Yasushi Ito, Wakayama (JP)

Correspondence Address: BIRCH STEWART KOLASCH & BIRCH, PO BOX 747, FALLS CHURCH, VA, 22040-0747, US

(21) Appl. No.: 12/374,727

(22) PCT Filed: Aug. 7, 2007
(86) PCT No.: PCT/JP2007/065406

§ 371 Date: Jan. 22, 2009

(30) Foreign Application Priority Data
Aug. 9, 2006 (JP) 2006-217062

(51) Int. Cl. B05D 5/06; C09D 11/02

(52) U.S. Cl. 427/256; 106/31.13

(57) ABSTRACT

The present invention relates to a water-based ink for ink-jet printing which is excellent in optical density when printed on plain papers, etc., and a water dispersion used in the water-based ink. The water dispersion for ink-jet printing according to the present invention includes a colorant, and secondary particles of a metal oxide which include a plurality of primary particles thereof connected to each other, wherein the metal oxide is at least one substance selected from the group consisting of silica, titanium oxide and cerium oxide, and the water-based ink for ink-jet printing according to the present invention contains the water dispersion.

### TECHNICAL FIELD

The present invention relates to water-based inks for ink-jet printing, and water dispersions for ink-jet printing for use in the water-based inks.

### BACKGROUND ART

In ink-jet printing methods, droplets of ink are directly ejected onto a recording medium from very fine nozzles and allowed to adhere to the recording medium, to form characters and images. The ink-jet printing methods have been rapidly spread because of their various advantages such as easiness of full coloration, low costs, capability of using a plain paper as the recording medium, non-contact with printed images and characters, etc.

Patent Document 1 discloses a water-based pigment dispersion capable of satisfying a storage stability, in particular, a long-term storage stability, and a water resistance of images printed therewith, at the same time, which contains a pigment a water-soluble organic solvent and a copolymer resin obtained from a styrene monomer and an acid group-containing monomer, wherein a content of the styrene monomer component in the copolymer resin is 50 to 90% by weight, and the dispersion farther contains inorganic oxide fine particles in an amount of 0.01 to 10% by weight on the basis of the weight of the pigment.

Patent Document 2 discloses a water-based ink-jet printing solution capable of providing printed images or characters having a good clarity and a high quality, and allowing resulting prints to exhibit sufficient water resistance and light resistance, which contains a pigment and colloidal silica.

Further, Patent Document 3 discloses an ink composition for ink-jet printing which is capable of exhibiting an excellent ejection stability from a printing head and providing printed images or characters having an excellent rubbing resistance, and contains a pigment, an inorganic oxide colloid, an alkali metal hydroxide and an aqueous medium.

In addition, Patent Document 4 discloses a coating composition for an ink receptor layer used in ink-jet printing which is capable of exhibiting a high ink absorptivity and forming printed images or characters having a high quality, and contains a silica sol and an aqueous resin, wherein the silica sol is formed by dispersing moniliform or beaded colloidal silica particles in water which are composed of spherical colloidal silica particles having an average particle size of from 10 to 50 nm and a metal oxide-containing silica linking the spherical colloidal silica particles to each other therethrough, and the spherical colloidal silica particles thus linked together are present only on one plane.

Patent Document 1: JP 2004-91590A

Patent Document 2: JP 9-227812A

Patent Document 3: JP 11-12516A

Patent Document 4: POT Pamphlet WO 00/15552

### DISCLOSURE OF THE INVENTION

### Problem to be Solved by the Invention

However, the water-based inks disclosed in the above Patent Documents are still insufficient in optical density when printed on plain papers.

The present invention relates to a water-based ink for ink-jet printing which is excellent in optical density when printed on plain papers, as well as a water dispersion for ink-jet printing for use in the water-based ink.

### Means for Solving Problem

The present invention relates to a water dispersion for ink-jet printing which includes a colorant, and secondary particles of a metal oxide which include a plurality of primary particles thereof connected to each other, wherein the metal oxide is at least one substance selected from the group consisting of silica, titanium oxide and cerium oxide, and a water-based ink for ink-jet printing which contains the water dispersion.

### EFFECT OF THE INVENTION

The water-based ink containing the water dispersion for ink-jet printing according to the present invention is capable of achieving a high optical density when printed on plain papers, etc.

### BEST MODE FOR CARRYING OUT THE INVENTION

### Secondary Particles of Metal Oxide which are Constituted from a Plurality of Primary Particles Thereof Connected to Each Other

The metal oxide used in the present invention is at least one substance selected from the group consisting of silica (silicon oxide), titanium oxide and cerium oxide. Among these metal oxides, silica is preferred from the viewpoint of a good dispersion stability.

In the present invention, the secondary particles of the metal oxide which are constituted from a plurality of primary particles thereof connected to each other (hereinafter referred to merely as “metal oxide secondary particles”) are used from the viewpoint of enhancing an optical density of printed images or characters. The “primary particles” constituting the metal oxide secondary particles as used herein mean “primary particles of the metal oxide”, i.e., metal oxide fine particles before they are bonded together which serve as a constitutional unit of the metal oxide secondary particles. The metal oxide fine particles used herein are usually colloidal particles. The shape of the metal oxide fine particles is not particularly limited, and the metal oxide fine particles may be of either a spherical shape or an elongated shape.

The metal oxide secondary particles are composed of a plurality of the metal oxide primary particles continuously connected to each other. The term “connected to each other” means that a plurality of the metal oxide primary particles are continuously bonded to each other by a chemical bond. For example, when the metal oxide is silica, the chemical bond means a siloxane bond, etc. When producing the metal oxide secondary particles, other metal oxides may be used as a substance through which the metal oxide primary particles are bonded to each other. Examples of the other metal oxides include divalent metals such as Ba, Ca and Mg, and trivalent metals such as Al.

The bonding portion between the metal oxide primary particles in the thus formed metal oxide secondary particles may be of either a constricted or non-constricted configuration which may be optionally selected depending upon the production method thereof. When the bonding portion between the metal oxide primary particles has a constricted configuration, the resulting metal oxide secondary particles have a moniliform or beaded shape. The moniliform or beaded metal oxide secondary particles may include those which are obtained by connecting a plurality of the metal oxide primary particles to each other into not only the moniliform or beaded shape but also a dumbbell shape, a necklace shape, etc. Whereas, when the bonding portion between the metal oxide primary particles has a non-constricted configuration, the resulting metal oxide secondary particles have an elongated shape.

The constricted configuration of the bonding portion in the moniliform or beaded metal oxide secondary particles and the extent of constriction at the bonding portion are not particularly limited. The bonding portion in the moniliform or beaded metal oxide secondary particles may be formed into any shape of from a slightly recognizable constriction to a large constriction, for example, a thread-like constriction. Also, the sectional shape of the constriction may include a partial circular shape such as a semi-circular shape, a trapezoidal shape and other rectangular shapes though not particularly limited thereto. In the present invention, from the viewpoint of a good optical density, there may be preferably used either the moniliform or beaded metal oxide secondary particles which are formed by continuously connecting a plurality of the metal oxide primary particles to each other into a moniliform or beaded shape, or the elongated metal oxide secondary particles which are formed by continuously connecting a plurality of the metal oxide primary particles to each other into an elongated shape.

The shape of the metal oxide secondary particles may be either a linearly extended shape, or a two-dimensionally or three-dimensionally curved shape, and may also be either linear or branched.

The “plurality of primary particles” mean two or more metal oxide primary particles. From the viewpoint of a good optical density, the number of the plurality of the metal oxide primary particles contained in the respective metal oxide secondary particles is preferably from 2 to 100 and more preferably from 5 to 50.

The shape of the metal oxide secondary particles as well as the shape and number of the primary particles constituting the respective metal oxide secondary particles may be determined by the observation using an electron microscope, etc. The number of the primary particles constituting the respective metal oxide secondary particles may be determined as an average value of the numbers of the primary particles contained in each of 50 metal oxide secondary particles observed in an electron microphotograph.

The average particle size of the primary particles constituting the metal oxide secondary particles is preferably from 1 to 100 nm and more preferably from 5 to 80 nm from the viewpoint of a good optical density. The average particle size of the primary particles is represented by an average diameter of 50 metal oxide primary particles observed in an electron microphotograph. More specifically, the average diameter of the primary particles may be measured by the method as described in the below-mentioned Examples.

The average diameter of the primary particles constituting the respective elongated metal oxide secondary particles is determined as an average value of sizes (diameters) as measured at optional 50 portions of the metal oxide secondary particles which are observed in an electron microphotograph thereof, whereas the average diameter of the primary particles constituting the moniliform or beaded metal oxide secondary particles having a constricted configuration is determined as an average value of diameters of 50 beads in the metal oxide secondary particles which are observed in an electron microphotograph thereof. When the respective beads have an major axis diameter and a minor axis diameter, namely, when the respective beads have an elongated shape, the minor axis diameters thereof are measured for determining the average diameter.

The average particle size of the metal oxide secondary particles is preferably from 40 to 300 nm, more preferably from 40 to 200 nm, still more preferably from 60 to 200 nm and further still more preferably from 60 to 150 nm from the viewpoint of a good optical density. The average particle size of the metal oxide secondary particles may be measured by a dynamic light scattering method, more specifically the method as described in the below-mentioned Examples.

When the metal oxide is silica, the silica secondary particles may be produced by the method as described in claim 2 and related portions of the specification of PCT Pamphlet WO 00/15552, the method as described in JP 2803134, the method as described in claim 2 and related portions of the specification of JP 2926915, etc., or substantially according to any of these methods.

Specific examples of the silica secondary particles usable in the present invention include “SNOWTEX-OUP” (average secondary particle size: 40 to 100 nm), “SNOWTEX-UP” (average secondary particle size: 40 to 100 nm), “SNOWTEX PS-M” (average secondary particle size: 80 to 150 nm), “SNOWTEX PS-MO” (average secondary particle size: 80 to 150 nm), “SNOWTEX PS-S” (average secondary particle size: 80 to 120 nm), “SNOWTEX PS-SO” (average secondary particle size: 80 to 120 nm) and “IPA-ST-UP” (average secondary particle size: 40 to 100 nm) all available from Nissan Chemical Industry, Co., Ltd., and “QUATRON PL-7” (average secondary particle size: 130 nm) available from Fuso Chemical Industry, Co., Ltd.

Specific examples of titanium oxide secondary particles include “PW-6030” (93 nm) available from Shokubai Kasei Co., Ltd. Specific examples of cerium oxide secondary particles include “NEEDRAL P-10” (49 nm) available from Tagi Chemical Co., Ltd.

The above metal oxide secondary particles may be used alone or in combination of any two or more thereof.

The metal oxide secondary particles used in the present invention are considered to exhibit the following effects. That is, when ejecting the ink containing the metal oxide secondary particles as an ink component onto a recording paper through nozzles, the metal oxide secondary particles are caught with fibers of the recording paper and, therefore, prevented from penetrating inside of the recording paper, so that the colorant used in the ink is also inhibited from penetrating into the recording paper, resulting in enhancement in optical density of printed images or characters.

In the present invention, the configuration of the metal oxide secondary particles upon adding to the dispersion is not particularly limited, and is usually a sol.

### (Colorant)

The colorant used in the water dispersion for ink-jet printing according to the present invention is preferably a pigment and a hydrophobic dye from the viewpoint of a good water resistance. Among them, the pigment is preferably used in order to allow the resulting water dispersion to exhibit a high weather resistance or the like which have been recently strongly demanded therefor.

The pigment and hydrophobic dye used in the water-based ink may be stably dispersed in the ink using a surfactant, a water-soluble polymer, a water-insoluble polymer, etc. In particular, the dye is preferably incorporated in particles of the water-insoluble polymer from the viewpoint of attaining a good optical density owing to inclusion of the metal oxide secondary particles.

The pigment used in the present invention may be either organic or inorganic. The organic or inorganic pigment may be used in combination with an extender pigment, if required.

Examples of the inorganic pigments include carbon blacks, metal sulfides and metal chlorides. In particular, among these inorganic pigments, carbon blacks are preferably used for black water-based inks. The carbon blacks may include furnace blacks, thermal lamp blacks, acetylene blacks and channel blacks.

Examples of the organic pigments include azo pigments, disazo pigments, phthalocyanine pigments, quinacridone pigments, isoindolinone pigments, dioxazine pigments, perylene pigments, perinone pigments, thioindigo pigments, anthraquinone pigments and quinophthalone pigments.

The hue of the organic pigments is not particularly limited. In the present invention, there may be used chromatic color pigments such as red-color organic pigments, yellow-color organic pigments, blue-color organic pigments, orange-color organic pigments and greenish orange-color organic pigments.

Specific examples of the preferred organic pigments include one or more pigments selected from the group consisting of C.I. Pigment Yellow 13, 17, 74, 83, 97, 109, 110, 120, 128, 139, 151, 154, 155, 174, 180; C1. Pigment Red 48, 57:1, 122, 146, 176, 184, 185, 188, 202; C1. Pigment Violet 19, 23; C1. Pigment Blue 15, 15:1, 15:2, 15:3, 15:4, 16, 60; and C1. Pigment Green 7, 36, with various product numbers.

Examples of the extender pigment include calcium carbonate and talc.

The hydrophobic dye is not particularly limited. In case of the hydrophobic dye contained in the water-insoluble polymer, from the viewpoint of allowing the dye to efficiently become included in the particles of the water-insoluble polymer, the solubility of the hydrophobic dye is preferably 2 g/L or more and more preferably from 20 to 500 g/L as measured at 25° C. on the basis of the organic solvent used upon the production of the water-insoluble polymer.

Examples of the hydrophobic dye include oil-soluble dyes and disperse dyes. Among these dyes, preferred are oil-soluble dyes.

Examples of the oil-soluble dyes include one or more dyes selected from the group consisting of C.I. Solvent Black, C.I. Solvent Yellow, C.I. Solvent Red, C.I. Solvent Violet, C.I. Solvent Blue, C.I. Solvent Green and C.I. Solvent Orange, with various product numbers.

Examples of the disperse dyes include one or more dyes selected from the group consisting of C.I. Disperse Yellow, C.I. Disperse Orange, C.I. Disperse Red, C.I. Disperse Violet, C.I. Disperse Blue and C.I. Disperse Green, with various product numbers.

Among these dyes, preferred are C.I. Solvent Yellow 29 and 30 for yellow colorant, C.I. Solvent Blue 70 for cyan colorant, C.I. Solvent Red 18 and 49 for magenta colorant, and C.I. Solvent Black 3 and 7 and nigrosine black dyes for black colorant.

The pigment used as the colorant preferably has an average primary particle size of from 40 to 180 nm, more preferably from 50 to 170 nm and still more preferably from 70 to 140 nm from the viewpoint of attaining a good dispersibility of the pigment and a good optical density of the resulting ink as well as preventing clogging of nozzles of a printer.

The average primary particle size of the pigment may be measured using a transmission electron microscope. More specifically, the average primary particle size may be represented by the number-average particle size which is determined by measuring diameters of 500 particles by image analysis using a transmission electron microscope available from Nippon Denshi Co., Ltd., and calculating an average value of the measured diameters. Meanwhile, when the pigment has a major axis diameter and a minor axis diameter, the average particle size is calculated from the major axis diameter.

Among the pigments, a self-dispersible pigment is preferably used from the viewpoints of a good optical density and a good dispersion stability. The “self-dispersible pigment” means a pigment onto a surface of which at least one salt-forming group in the form of an anionic or cationic hydrophilic group is bonded either directly or through the other atom group to thereby allow the pigment to be dispersed in an aqueous medium without using a surfactant or a resin.

Examples of the other atom group include an alkylene group having 1 to 24 carbon atoms and preferably 1 to 12 carbon atoms, a substituted or unsubstituted phenylene group and a substituted or unsubstituted naphthylene group.

As the anionic hydrophilic group, any optional groups may be used as long as they exhibit a high hydrophilic property sufficient to allow the pigment particles to be stably dispersed in the aqueous medium. Specific examples of the anionic hydrophilic group include a carboxyl group (—COOM¹), a sulfonic group (—SO₃M¹), a phosphoric group (—PO₃M¹₂), —SO₂NH₂, —SO₂NHCOR¹, and dissociated ions thereof such as —COO⁻, —SO₃⁻, —PO₃²⁻ and —PO₃ ⁻M¹.

Examples of M¹ in the above formulae include a hydrogen atom; alkali metals such as lithium, sodium and potassium; an ammonium group; and organic ammonium groups such as monomethyl ammonium, dimethyl ammonium, trimethyl ammonium, monoethyl ammonium, diethyl ammonium, triethyl ammonium, monomethanol ammonium, dimethanol ammonium and trimethanol ammonium.

R¹ is an alkyl group having 1 to 12 carbon atoms, a substituted or unsubstituted phenyl group or a substituted or unsubstituted naphthyl group.

Among these anionic hydrophilic groups, a carboxyl group (—COOM¹) and a sulfonic group (—SO₃M¹) are especially preferred from the viewpoint of a good dispersion stability.

Examples of the cationic hydrophilic group include an ammonium group and an amino group.

The content of the anionic or cationic hydrophilic group is not particularly limited, and is preferably from 50 to 5,000 μmol/g and more preferably from 100 to 3,000 μmol/g per one gram of the self-dispersible pigment.

The pigment used as the self-dispersible pigment is not particularly limited, and may be appropriately selected from the above inorganic and organic pigments. Among these pigments, from the viewpoint of a good dispersion stability, the carbon blacks are preferably used, in particular, for black water-based inks.

The average particle size of the self-dispersible pigment is preferably from 40 to 300 nm and more preferably from 50 to 200 nm from the viewpoint of a good dispersion stability of the resultant dispersion. Meanwhile, the average particle size of the self-dispersible pigment may be measured by a dynamic light scattering method, more specifically, by the method as described in the below-mentioned Examples.

Examples of the commercially available self-dispersible pigment (carbon black) include “CAB-O-JET 200” and “CAB-O-JET 300” both available from Cabot Corp., “BONJET CW-1” and “BONJET CW-2” both available from Orient Chemical Industries Co., Ltd., and “Aqua-Black 162” (carboxyl group content: about 800 μmol/g) available from Tokai Carbon Co., Ltd.

These self-dispersible pigments may be used alone or in combination of any two or more thereof.

### (Water Dispersion/Water-Based Ink)

Upon producing the water dispersion containing the colorant and the metal oxide secondary particles according to the present invention, the order of mixing of the respective components is optional. The water dispersion of the present invention may also contain the metal oxide primary particles together with the metal oxide secondary particles, unless the inclusion thereof adversely affects the aimed effects of the present invention.

The contents of the respective components in the water dispersion and the water-based-ink for ink-jet printing are as follows.

The content of the metal oxide secondary particles is preferably from 0.1 to 15% by weight, more preferably from 0.5 to 5% by weight and still more preferably from 1 to 4% by weight in order to enhance an optical density of the resultant dispersion or ink and impart a good dispersion stability thereto.

The content of the colorant is preferably from 1 to 10% by weight, more preferably from 2 to 10% by weight, still more preferably from 3 to 10% by weight and further still more preferably from 4 to 8% by weight in order to enhance an optical density of the resulting dispersion or ink.

The content ratio of the colorant to the metal oxide secondary particles [weight ratio: (colorant/metal oxide secondary particles)] is preferably from 0.1 to 20, more preferably from 0.5 to 10 and still more preferably from 2 to 5 in order to exhibit the effect of enhancing an optical density owing to the inclusion of the metal oxide secondary particles and attain a good dispersion stability in the resulting water dispersion and water-based ink.

The ratio of the average particle size of the pigment to the average particle size of the metal oxide secondary particles [(average particle size of pigment)/(average particle size of metal oxide secondary particles)] is preferably from 1/5 to 5/1 and more preferably from 1/3 to 3/1 in order to exhibit the effect of enhancing an optical density owing to the inclusion of the metal oxide secondary particles and attain a good dispersion stability in the resulting water dispersion and water-based ink.

The water dispersion of the present invention may be directly used as a water-based ink containing water as a main solvent. Alternatively, the water dispersion may be further mixed with various additives ordinarily used for water-based inks for ink-jet printing such as wetting agents, penetrants, dispersants, viscosity modifiers, defoaming agents, mildew-proof agents and rust preventives.

Thus, the water dispersion of the present invention is in the form of a water-based ink containing water as a main solvent. The content of water in the water dispersion and the water-based ink according to the present invention is preferably from 30 to 90% by weight and more preferably from 40 to 80% by weight.

The surface tension of the water dispersion of the present invention is preferably from 30 to 65 mN/m and more preferably from 35 to 60 mN/m as measured at 20° C., and the surface tension of the water-based ink of the present invention is preferably from 23 to 50 mN/m, more preferably from 23 to 45 mN/m, still more preferably from 23 to 40 mN/m and further still more preferably from 23 to 30 mN/m as measured at 20° C.

The viscosity of the water dispersion having a solid content of 20% by weight according to the present invention is preferably from 1 to 12 mPa·s, more preferably from 1 to 9 mPa·s, still more preferably from 2 to 6 mPa·s and further still more preferably from 2 to 5 mPa·s as measured at 20° C. in order to produce a water-based ink having a good viscosity.

The viscosity of the water-based ink according to the present invention is preferably from 2 to 12 mPa·s, more preferably from 2.5 to 10 mPa·s and still more preferably from 2.5 to 6 mPa·s in order to maintain a good ejection property thereof.

### (Method for Improving Optical Density)

In the method for improving an optical density according to the present invention, the printed images or characters can be enhanced in optical density by using the water-based ink of the present invention for ink-jet printing. The recording medium used in the above method is not particularly limited, and any of ordinarily available plain papers and coated papers can be used From the viewpoint of exhibiting the aimed effect of the present invention owing to the inclusion of the metal oxide fine particles, the plain papers are preferably used.

The method for improving an optical density according to the present invention may be applied to any of ink-jet printing methods as long as the water-based ink of the present invention is used therein. In particular, the method of the present invention can be suitably applied to such an ink-jet printing method in which plain papers are printed with the water-based ink of the present invention using a high-speed printer, for example, at a printing speed of preferably from 3 to 30 sheets/min, more preferably from 5 to 30 sheets/min and still more preferably from 10 to 30 sheets/min. Meanwhile, the above printing speed means a printing speed of a printer upon printing a standard pattern (J6) (size: A4) provided from Japan Electronics and Information Technology Industries Association (JEITA) under the condition in which a printing mode of the printer is set to High-Speed (Fine).

### EXAMPLES

In the following Examples and Comparative Examples, the “part(s)” and “%” indicate “part(s) by weight” and “% by weight”, respectively, unless otherwise specified.

### Examples 1 to 3 and Comparative Examples 1 AND 2

The following components of the ink composition were mixed at 25° C. with each other such that a total amount of the components was 100 parts by weight, and then stirred to prepare a dispersion. The resulting dispersion was filtered through a 0.8 μm-mesh filter to obtain a water-based ink.

(Ink Composition)

| | |
|---|---|
| Water dispersion of self-dispersible carbon | 7 parts by weight |
| black (tradename “BONJET CW-2” | (in terms of pigment |
| available from Orient Chemical Industry Co., | solid content) |
| Ltd.; solid content: 15%; average | |
| particle size: 150 nm) | |
| Silica secondary particles (as shown in Table 1) | 2 parts by weight |
| | (in terms of |
| | solid content) |
| Glycerol | 5 parts by weight |
| 2-Pyrrolidone | 5 parts by weight |
| Isopropyl alcohol | 2 parts by weight |
| Acetylenol EH (available from Kawaken Fine | 1 part by weight |
| Chemical Co., Ltd.) | |
| Water | Balance |

Meanwhile, in Comparative Example 1, water was added to the ink composition in place of the silica particles.

The ejection property (1) and the optical density (2) of the obtained water-based inks were evaluated by the following methods. The results are shown in Table 1.

### (1) Ejection Property

Solid image printing was carried out on a high-quality coated paper available from Canon Corp., using an ink-jet printer “Model PM930C” commercially available from Seiko Epson Co., Ltd., under the printing condition set to Fine Mode (high-speed printing mode). After drying, the printed images or characters were observed by naked eyes to evaluate an ejection property of the ink according to the following evaluation criteria.

### [Evaluation Criteria]

◯: No slippage (or misdirection) nor lack

Δ: Slippage (or misdirection) occurred;

X: Both slippage (or misdirection) and lacks occurred.

Meanwhile, the “slippage (or misdirection)” as used herein means the condition in which no nozzles with failure of ink ejection are present, but thin white stripes are formed on a recording medium, whereas the “lack” as used herein means the condition in which any nozzles with failure of ink ejection are present, and thick white stripes are formed on the recording medium.

### (2) Optical Density

Solid image printing was carried out on a recycled paper for PPC available from Nippon Kakoh Seishi Co., Ltd., using the above ink-jet printer. The thus printed paper was naturally dried at room temperature for 24 h, and then the optical density thereof was measured by a Macbeth densitometer “RD918” (product number) available from Gretag-Macbeth Corp.

Meanwhile, the average particle size of the metal oxide (silica) primary particles, the average particle size of the metal oxide (silica) secondary particles composed of a plurality of the primary particles connected to each other, and the average particle size of the self-dispersible pigment were measured by the following methods.

### (3) Average Particle Size of Metal Oxide (Silica) Primary Particles and Shape of Secondary Particles

The particle sizes of the 50 primary particles were observed by naked eyes and measured on a microphotograph obtained using a transmission electron microscope “JEM2100FX” available from Nippon Denshi Co., Ltd., and an average values of the measured particle sizes was calculated to determine an average particle size of the primary particles. Also, the shape of the secondary particles was determined from the same microphotograph.

### (4) Method of Measuring Average Particle Sizes of Metal Oxide (Silica) Secondary Particles and Self-Dispersible Pigment

The average particle sizes of the metal oxide (silica) secondary particles and the self-dispersible pigment were measured by using a laser particle analyzing system “ELS-8000” (cumulant analysis) available from Otsuka Denshi Co., Ltd. The measurement was conducted at a temperature of 25° C., an angle between incident light and detector of 90° and a cumulative frequency of 100 times, and a refractive index of water (1.333) was input to the analyzing system as a refractive index of the dispersing medium. Further, the measurement was usually conducted by adjusting a concentration of the dispersion to be measured to 5×10⁻³% by weight.

TABLE 1

| | | | | Average | | |
|---|---|---|---|---|---|---|
| | | | | particle | | |
| | Silica secondary particles | | | size of silica | | |
| | | Average | | primary | | |
| | | particle | Content | particles | Optical | Ejection |
| | Tradename | size (nm) | (wt %) | (nm) | density | property |
| Example 1 | SNOWTEX | 100 | 2 | 13 | 1.50 | ◯ |
| | PS-S | | | | | |
| | (moniliform or | | | | | |
| | beaded silica) | | | | | |
| Example 2 | SNOWTEX | 115 | 2 | 38 | 1.49 | ◯ |
| | PS-M | | | | | |
| | (moniliform or | | | | | |
| | beaded silica) | | | | | |
| Example 3 | SNOWTEX | 65 | 2 | 14 | 1.47 | ◯ |
| | UP (elongated | | | | | |
| | silica) | | | | | |
| Example 4 | PL-7 | 130 | 2 | 70 | 1.49 | ◯ |
| | (moniliform or | | | | | |
| | beaded silica) | | | | | |
| Comparative | — | — | 0 | — | 1.43 | ◯ |
| Example 1 | | | | | | |
| Comparative | SNOWTEX 20 | — | 2 | 15 | 1.39 | ◯ |
| Example 2 | (spherical | | | | | |
| | silica) | | | | | |

### INDUSTRIAL APPLICABILITY

The water dispersion of the present invention provides a water-based ink capable of achieving a high optical density when printed on plain papers, etc., and are therefore suitably used as a water-based ink for ink-jet printing and a water dispersion for ink-jet printing used in the water-based ink.

1. A water dispersion for ink-jet printing, comprising a colorant, and secondary particles of a metal oxide which comprise a plurality of primary particles thereof connected to each other, wherein the metal oxide is at least one substance selected from the group consisting of silica, titanium oxide and cerium oxide.

2. The water dispersion according to claim 1, wherein the secondary particles of the metal oxide have a moniliform or headed shape, or an elongated shape.

3. The water dispersion according to claim 1 or 2, wherein the colorant is a self-dispersible pigment.

4. The water dispersion according to claim 1, wherein the secondary particles of the metal oxide have an average particle size of from 40 to 300 nm as measured by a dynamic light scattering method.

5. The water dispersion according to claim 1, wherein a content of the secondary particles of the metal oxide is from 0.1 to 15% by weight.

6. The water dispersion according to claim 1, wherein a content ratio of the colorant to the secondary particles of the metal oxide (colorant/secondary particles of metal oxide) in terms of a weight ratio therebetween is from 0.1 to 20.

7. The water dispersion according to claim 1, wherein the metal oxide is silica.

8. A water-based ink for ink-jet printing comprising the water dispersion as defined in claim 1.

9. A method for improving an optical density of printed images or characters comprising using the water-based ink as defined in claim 8 for ink-jet pointing.

10. A use of a water dispersion for ink-jet printing, wherein the water dispersion comprises a colorant, and secondary particles of a metal oxide which comprise a plurality of primary particles thereof connected to each other, and the metal oxide is at least one substance selected from the group consisting of silica, titanium oxide and cerium oxide.

11. A use of the water-based ink as defined in claim 8 for ink-jet printing.
